(19) United States
(12) Patent Application Publication
(10) Pub. No.: US 2026/0087237 A1
(43) Pub. Date: Mar. 26, 2026

(54) CONTEXTUALIZATION AND OPTIMIZED USER PROMPTING IN AUTOMATED NOTE TAKING

(71) Applicant: International Business Machines Corporation, Armonk, NY (US)

(72) Inventors: Logan Bailey, Atlanta, GA (US); Jeremy R. Fox, Georgetown, TX (US); Zachary Augustus Silverstein, Georgetown, TX (US); Fernando Luiz Koch, Palm Beach Gardens, FL (US)

(21) Appl. No.: 18/897,460

(22) Filed: Sep. 26, 2024

(51) Int. Cl. G06F 40/166; G06F 16/33; G06F 16/34; G06F 40/30

(52) U.S. Cl. CPC G06F 40/166; G06F 16/3344; G06F 16/345; G06F 40/30

(57) ABSTRACT

According to one embodiment, a method, computer system, and computer program product for providing optimized automated note-taking. The embodiment may include transcribing audio data of a current user interaction into text data. The embodiment may include analyzing the text data using natural language processing to identify a context of the current user interaction. The embodiment may include generating, via a generative artificial intelligence (GenAI) model, one or more summaries of contextually relevant portions of the text data. The embodiment may include creating one or more prompts for the GenAI model based on the one or more summaries. The embodiment may include querying the GenAI model using the one or more prompts and using one or more existing prompts from a previous user interaction to identify a contextual opportunity for notification. The embodiment may include notifying a user of the contextual opportunity for notification during the current user interaction.

### BACKGROUND

The present invention relates generally to the field of computing and artificial intelligence (AI), and more particularly to automated note-taking.

Automated note-taking during human interactions, often termed impromptu note-taking, involves the use of AI tools to capture, summarize, and organize main points from conversations, meetings, or other forms of human interaction in real-time and without manual intervention. For instance, generative AI may enhance automated note-taking by leveraging natural language processing (NLP) insights and pre-trained AI models (e.g., advanced language models, large language models (LLMs)) to provide real-time transcription, summarization, and key-point extraction. Thus, generative AI may enable users to capture and organize large amounts of information (e.g., information captured by a user via Internet-of-Things (IoT) devices and wearables) with increased efficiency and accuracy. Through focusing on context awareness and adapting to specific domains, the use of such AI tools may ensure that important information is identified while users remain engaged in their interactions.

### SUMMARY

According to one embodiment, a method, computer system, and computer program product for providing optimized automated note-taking. The embodiment may include transcribing audio data of a current user interaction into text data. The embodiment may include analyzing the text data using natural language processing to identify a context of the current user interaction. The embodiment may include generating, via a generative artificial intelligence (GenAI) model, one or more summaries of contextually relevant portions of the text data. The embodiment may include creating one or more prompts for the GenAI model based on the one or more summaries. The embodiment may include querying the GenAI model using the one or more prompts and using one or more existing prompts from a previous user interaction to identify a contextual opportunity for notification. The embodiment may include notifying a user of the contextual opportunity for notification during the current user interaction.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary computer environment according to at least one embodiment.

FIG. 2 illustrates an operational flowchart for prompting a user with one or more relevant text summaries at contextually opportunistic moments during a user interaction via a contextually optimized note-taking and prompting process, according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

The present invention relates generally to the field of computing and artificial intelligence (AI), and more particularly to automated note-taking. The following described exemplary embodiments provide a system, method, and program product to, among other things, enable automated note-taking during human interactions which captures and stores contextually meaningful information from events and/or locations in a private and secure manner, and presents stored information at later contextually opportunistic time. Therefore, the present embodiment has the capacity to improve the technical field of automated note-taking by dynamically monitoring and capturing information of a user’s interaction, identifying and storing contextually significant content of a captured interaction, and proactively notifying a user of previously stored contextually significant content during a later interaction, thus ensuring that the user captures and retains significant information and enhancing the overall note-taking process.

As previously described, automated note-taking during human interactions, often termed impromptu note-taking, involves the use of AI tools to capture, summarize, and organize main points from conversations, meetings, or other forms of human interaction in real-time and without manual intervention. For instance, generative AI may enhance automated note-taking by leveraging natural language processing (NLP) insights and pre-trained AI models (e.g., advanced language models, large language models (LLMs)) to provide real-time transcription, summarization, and key-point extraction. Thus, generative AI may enable users to capture and organize large amounts of information (e.g., information captured by a user via Internet-of-Things (IoT) devices and wearables) with increased efficiency and accuracy. Through focusing on context awareness and adapting to specific domains, the use of such AI tools may ensure that important information is identified while users remain engaged in their interactions.

As mentioned above, information of a user’s interaction may be captured by IoT devices and/or wearable computing devices of the user. As the proliferation and utilization of such devices (e.g., smartphones, smartwatches, smart glasses) increase, an overload of captured information stemming from interactions of the user may result. While these devices allow for the accumulation of vast amounts of audio, visual, and textual data from various events and locations, challenges may lie in the ability to discern crucial (i.e., contextually relevant) information which is worthy of retention. Additionally, privacy concerns may need to be addressed while handling sensitive personal information. The current absence of an efficient and tailored system for automatically capturing meaningful notes during user interactions observed by applications running on IoT and/or wearable devices may lead to a situation where a user misses an opportunity to register valuable insights and knowledge stemming from their interactions. It may therefore be imperative to have a contextually optimized note-taking and prompting system in place to dynamically capture real-time information resulting from a user interaction, identify and store contextually significant insights of the interaction, and proactively notify the user of one or more stored insights at contextually opportune times during a later user interaction. Thus, embodiments of the present invention may be advantageous to, among other things, collect data (e.g., audio, visual, and/or text data) of a user interaction via one or more IoT devices and/or wearable computing devices of the user, receive user preferences for automated note-taking and notification, transcribe captured audio data of a user interaction, perform NLP processing on transcribed audio data to identify a context and one or more attributes of a user interaction, utilize a pre-trained generative AI model to identify and summarize contextually relevant portions of information from a user interaction based on an identified context and user preferences, store contextually relevant portions of information of a user interaction in a private and secure manner, create prompts for a generative AI model based on one or more identified contexts, user preferences, and/or one or more summarized contextually relevant portions, query a generative AI model using created prompts to identify contextual opportunities (i.e., contextually similar summarized portions of information) between different interactions of a user, notify a user of identified contextual opportunities from a previous interaction, determine an optimized window of time for user notification of identified contextual opportunities, and receive feedback from a user regarding summarized contextually relevant portions and notifications of identified contextual opportunities. The present invention does not require that all advantages need to be incorporated into every embodiment of the invention.

According to at least one embodiment, a contextually optimized note-taking and prompting (CONTP) program may capture data of a current user interaction with one or more other individuals. The data may include audio and/or video data of the interaction captured via an IoT device of the user. The data may also include metadata of the interaction such as environmental information (e.g., user geolocation data, location details, IoT device capabilities) captured by the IoT device. According to at least one embodiment, the CONTP program may transcribe received audio data into text and perform NLP processing on the text to identify a context and one or more attributes of the interaction. Attributes of the interaction may also be identified from the received metadata of the interaction. According to at least one embodiment, the CONTP program may utilize a generative AI (GenAI) model to create one or more text summaries of contextually relevant portions of the interaction. Furthermore, the CONTP program may also create one or more prompts for the GenAI model based on the summaries of contextually relevant portions and store the created prompts within a user repository of contextualized notes. According to at least one embodiment, the CONTP program may query the GenAI model using the created prompts, in addition to using any existing prompts within the repository which were created by the CONTP program during previous user interactions, in order to identify any contextual opportunities for user notification during the current user interaction. The CONTP program may then notify the user of any identified contextual notification opportunities via the IoT device of the user.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The following described exemplary embodiments provide a system, method, and program product to enhance automated note-taking during human interaction through the capture and storage of meaningful information from the interaction and the utilization of real-time GenAI-based context awareness and identification of contextual notification opportunities to provide a user with proactive assistance and insights during an interaction with another person.

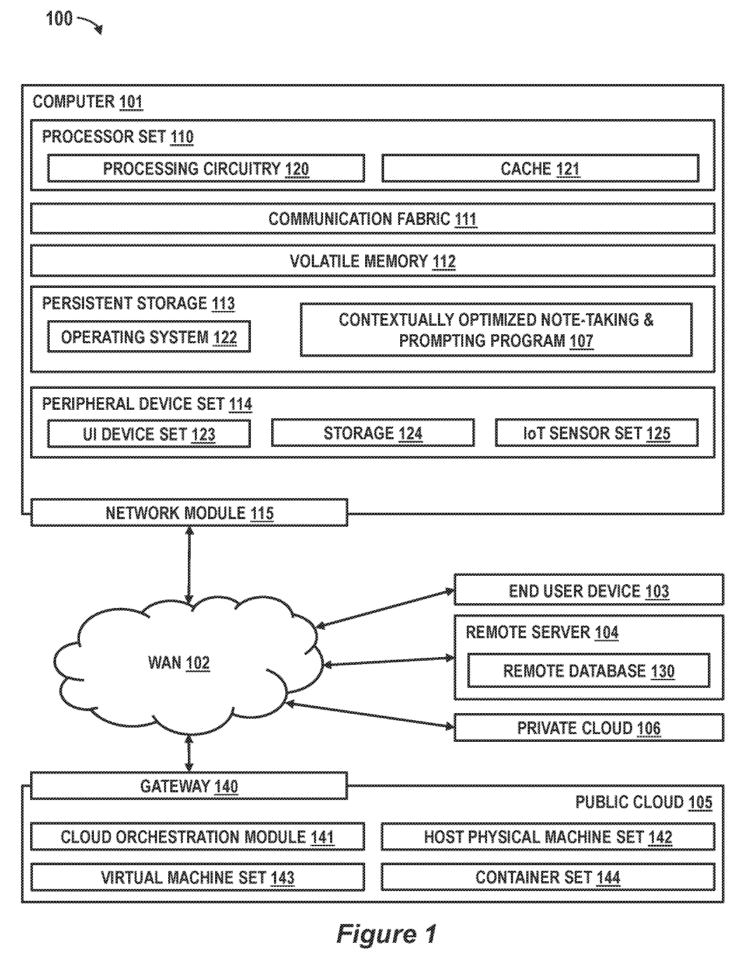

Referring to FIG. 1, an exemplary computing environment 100 is depicted, according to at least one embodiment. Computing environment 100 contains an example of an environment for the execution of at least some of the computer code involved in performing the inventive methods, such as contextually optimized note-taking & prompting (CONTP) program 107. In addition to CONTP program 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and CONTP program 107), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smartphone, smartwatch or other wearable computer, mainframe computer, quantum computer or any other form of computer or mobile device now known or to be developed in the future that is capable of running a program and accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in CONTP program 107 within persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in CONTP program 107 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as smart glasses, smartwatches, AR/VR-enabled headsets, and wearable cameras), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, another sensor may be a motion detector, another sensor may be a global positioning system (GPS) receiver, another sensor may be a smart lock, and yet another sensor may be a digital image capture device (e.g., a camera) capable of capturing and transmitting one or more still digital images or a stream of digital images (e.g., digital video).

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network or a mesh network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a client of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on. According to at least one other embodiment, in addition to taking any of the forms discussed above with computer 101, EUD 103 may further be an IoT enabled device (e.g., a smartphone, a smartwatch, smart glasses) capable of connecting to computer 101 via WAN 102 and network module 115 and capable of receiving instructions from CONTP program 107.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

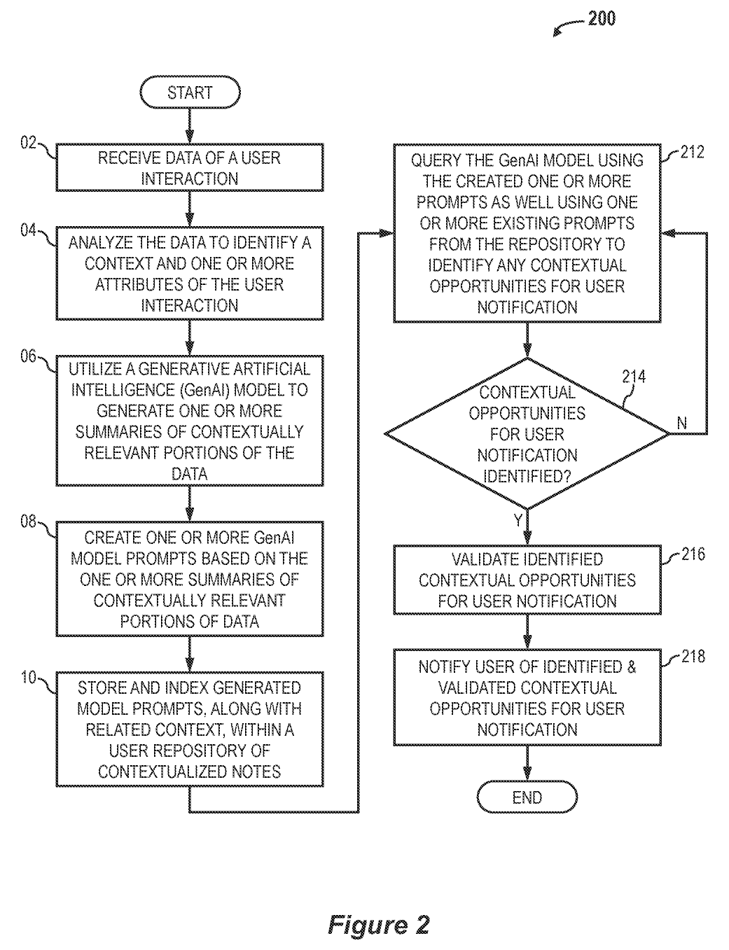

The CONTP program 107 may be a program capable of collecting data (e.g., audio, visual, and/or text data) of a user interaction via one or more IoT devices and/or wearable computing devices of the user, receiving user preferences for automated note-taking and notification, transcribing captured audio data of a user interaction, performing NLP processing on transcribed audio data to identify a context and one or more attributes of a user interaction, utilizing a pre-trained generative AI model to identify and summarize contextually relevant portions of information from a user interaction based on an identified context and user preferences, storing contextually relevant portions of information of a user interaction in a private and secure manner, creating prompts for a generative AI model based on one or more identified contexts, user preferences, and/or one or more summarized contextually relevant portions, querying a generative AI model using created prompts to identify contextual opportunities (i.e., contextually similar summarized portions of information) between different interactions of a user, notifying a user of identified contextual opportunities from a previous interaction, determining an optimized window of time for user notification of identified contextual opportunities, and receiving feedback from a user regarding summarized contextually relevant portions and notifications of identified contextual opportunities. In at least one embodiment, CONTP program 107 may require a user to opt-in to system usage upon opening or installation of CONTP program 107, or upon accessing a digital assistant within which CONTP program 107 has been integrated. Notwithstanding depiction in computer 101, CONTP program 107 may be stored in and/or executed by, individually or in any combination, end user device 103, remote server 104, public cloud 105, and private cloud 106 so that functionality may be separated among the devices. The contextually optimized note-taking and prompting method is explained in further detail below with respect to FIG. 2.

Referring now to FIG. 2, an operational flowchart for prompting a user with one or more relevant text summaries at contextually opportunistic moments during a user interaction via a contextually optimized note-taking and prompting process 200 is depicted according to at least one embodiment. At 202, CONTP program 107 receives data of a current interaction of a user with one or more other individuals. According to at least one embodiment, the received data may be audio and/or video data captured, at the direction of CONTP program 107, by an IoT device (e.g., a smartphone, a smartwatch, smart glasses) in possession of the user during the interaction. For example, CONTP program 107 may be implemented as a digital assistant integrated within a smartphone or smartwatch of the user and may be configured to automatically begin capture of audio and/or video data, using a built-in microphone and/or camera, whenever the user engages in conversation with one or more other individuals. According to at least one embodiment, the data received by CONTP program 107 may also include metadata of the interaction such as environmental information (e.g., user geolocation data, current user activities, location/event details, & IoT device capabilities) captured by various sensors of the IoT device. According to at least one other embodiment, the data received by CONTP program 107 may be current audio and/or video data streamed to and/or received by the IoT device of the user (e.g., a podcast and/or a lecture being listened to and/or watched by the user). According to at least one embodiment, prior to step 202, CONTP program 107 may receive user preferences which control activation of CONTP program 107 to capture audio and/or video data of user interactions via one or more IoT devices of the user. For example, the user may configure CONTP program 107 to be continuously active, active during specified time periods, or to become active in response to a trigger such as detected speech by the user or a detected activation word specified by the user.

As mentioned above and according to at least one other embodiment, prior to data of a user interaction being captured by CONTP program 107, CONTP program 107 may execute a set-up process through which a user may opt-in to interaction monitoring by CONTP program 107 and register one or more IoT devices associated with the user. As part of the registration process, CONTP program 107 may collect data from the user including user identification information (e.g., user ID and contact information), user preferences, and information of the IoT devices associated with the user. User preference data may include activation settings for CONTP program 107, notification preferences (e.g., text and/or audible notifications), contextual similarity thresholds, timing threshold(s) for notifications, generative AI prompt creation rules and/or templates. Information of the one or more IoT devices associated with the user may include respective technical specifications and capabilities of an IoT device. Also, as a result of the registration process, CONTP program 107 may be enabled to access and receive (i.e., monitor) real-time data from an IoT device of the user such as, but not limited to, data of an interaction of the user and device status updates (e.g., remaining battery charge). According to such an embodiment, CONTP program 107 may store collected data within a created user specific data structure (e.g., a respective data file or data array). User specific data structures created by CONTP program 107 during a set-up process may be stored within storage 124 or remote database 130 for later modification and/or reference by CONTP program 107 during process 200.

Next, at 204, CONTP program 107 analyzes the data received at 202 to identify a context and one or more attributes of the current interaction of the user. According to at least one embodiment, in performing the analysis, CONTP program 107 may transcribe received audio data of the interaction into text and perform natural language processing on the text to identify a context (e.g., a topic or topics of discussion) and one or more attributes of the interaction. The one or more attributes may include details such as, but not limited to, sentiment of the interaction, tone(s) of the interaction, named entities of the interaction, a number of parties to the interaction, and any other insights which may be gleamed from the application of known NLP techniques on the transcribed text. Additionally, according to at least one embodiment, attributes of the interaction may also be identified from the received metadata of the interaction. For example, the one or more attributes may also include a geolocation of the user, current user activity information accessed from a calendar system or social media account of the user, location and/or event details accessed from the internet, and IoT device capabilities and statuses.

At 206, CONTP program 107 utilizes a generative artificial intelligence model to generate one or more text summaries of contextually relevant portions of the transcribed text. According to at least one embodiment, CONTP program 107 may utilize a pre-trained generative AI model (e.g., a large language model, a small generative model) to identify and summarize contextually relevant portions of the transcribed text from the current user interaction based on the identified context of the interaction and any identified attributes of the interaction. For example, CONTP program 107 may use an advanced language model to identify and classify portions of the transcribed text of the interaction as contextually meaningful based on those portions containing text which relates to an identified topic of the interaction. Moreover, the identification and classification of contextually meaningful portions of the transcribed text may also be based on identified attributes of the interaction (e.g., sentiment, tone(s), named entities, number of parties) associated with those portions. In furtherance of the above example, CONTP program 107 may use the advanced language model to summarize those portions of the transcribed text which were identified as contextually meaningful (i.e., relevant). According to at least one embodiment, CONTP program 107 may store identified portions of the transcribed text, as well as their respective generated summaries, within a user repository of contextualized notes within storage 124 or remote database 130. According to at least one other embodiment, prior to their storage within the repository, CONTP program 107 may present the generated summaries to the user for moderation and potential edit. For example, CONTP program 107 may present a generated summary to a user for edit and save any user edits to the summary. As another example, CONTP program 107 may present the user with multiple versions of a generated summary and enable selection of a particular summary by the user. In such an embodiment, details of user edits and selections may be utilized by CONTP program 107 as further training feedback to the generative AI model for use as guidance in the generation of future summaries.

Next, at 208, CONTP program 107 creates one or more prompts for the generative AI model based on generated one or more text summaries of contextually relevant portions of the transcribed text. According to at least one embodiment, CONTP program 107 may create the prompts according to prompt creation rules based on any combination of the identified context of the interaction, the identified attributes of the interaction, user preference data, and generated text summaries of contextually relevant portions of the transcribed text. As such, a prompt created by CONTP program 107 may include a description of a contextually relevant portion of text resulting from a conversation between the user and one or more other individuals. For example, a created prompt may include a text summary generated at step 206 and may also include the identified context of the interaction and an identification of interacting parties (e.g., the names of the user and the one or more other individuals).

At 210, CONTP program 107 stores and indexes the generative AI model prompts created at step 208 within the user repository of contextualized notes. According to at least one embodiment, CONTP program 107 may also associate the context of the current user interaction (e.g., a topic of discussion) identified at step 204 with each created prompt and store the identified context of the current user interaction along with each created prompt within the user repository of contextualized notes. According to at least one embodiment, prompts stored within the user repository of contextualized notes may be indexed according to a timestamp or a timeframe, and/or an identified context, of the respective user interactions during which they were created. Identified portions of transcribed text, as well as their respective generated summaries, stored within the repository may also be similarly indexed. As such, the user repository of contextualized notes may contain respective model prompts, identified portions of transcribed text, and generated summaries from one or more previous interactions of the user monitored by CONTP program 107. According to at least one other embodiment, the user repository of contextualized notes may be located within a storage of the IoT device of the user and may be accessible for later modification and/or reference by CONTP program 107 during process 200.

Next, at 212, CONTP program 107 queries the generative AI model using the one or more prompts created at step 208, as well as using one or more existing prompts stored within the user repository of contextualized notes, to identify any contextual opportunities for user notification during the current user interaction. According to at least one embodiment, CONTP program 107 may query the GenAI model using prompts created during the current user interaction in addition to using prompts created by CONTP program 107 during a previous user interaction to identify, within the repository, one or more contextual opportunities for user notification during the current user interaction via the IoT device of the user. According to at least one embodiment, a contextual opportunity for user notification may include a portion of transcribed text and/or its corresponding summary which were identified and/or generated by CONTP program 107 during a previous user interaction, and which may be contextually relevant (e.g., contextually similar) to the identified context of the current user interaction. For example, during the current user interaction, CONTP program 107 may, through prompting of the GenAI model as described above, identify a transcribed portion of text and/or a generated summary from a previous user interaction which relates to a same topic of the current user interaction. Such text transcriptions and/or summaries may be selected by CONTP program 107 for presentation to the user (i.e. notification) via their IoT device during the current user interaction.

At 214, CONTP program 107 determines whether any contextual opportunities for user notification during the current user interaction have been identified. In making this determination, CONTP program 107 may utilize the generative AI model to determine a measure of contextual similarity between an identified contextual opportunity for user notification (i.e., a portion of transcribed text and/or its corresponding summary from a previous user interaction) and the identified context of the current user interaction. CONTP program 107 may also similarly determine a contextual similarity between the identified contextual opportunity for user notification and one or more contextually relevant portions of the transcribed text, and/or their corresponding generated summaries, of the current user interaction. Known techniques for determining contextual similarity (e.g., cosine similarity, Euclidean distance, attention mechanisms) may be used. According to at least one embodiment, as an additional part in making this determination, CONTP program 107 may also query the generative AI model to determine if presentation to the user of the identified contextual opportunity for user notification falls within an optimal window of opportunity (i.e. an optimal window of time) based on inputs including, at least, user preference data and an identification time of the identified contextual opportunity for user notification. In response to determining that a contextual opportunity for user notification during the current user interaction has been identified (step 214, “Y” branch), the contextually optimized note-taking and prompting process 200 may proceed to step 216. In response to determining that a contextual opportunity for user notification during the current user interaction has not been identified (step 214, “N” branch), the contextually optimized note-taking and prompting process 200 may return to step 212 for continued querying of the generative AI model.

Next, at 216, in response to determining that a contextual opportunity for user notification during the current user interaction has been identified, CONTP program 107 validates the identified contextual opportunity. According to at least one embodiment, CONTP program 107 perform the validation according to rules based on user preference data, capabilities of the IoT device, the identified context of the current user interaction, contextually relevant portions of transcribed text of the current user interaction, generated summaries of the current user interaction, or any combination thereof. According to at least one other embodiment, information of validated contextual opportunities may be used by CONTP program 107 as feedback to the generative AI model to augment the identification of contextual opportunities for user notification (i.e., step 212).

At 218, CONTP program 107 notifies the user of the identified and validated contextual opportunity for user notification. According to at least one embodiment, CONTP program 107 may present to the user an identified and validated portion of transcribed text, and/or its corresponding summary, from a previous user interaction via the IoT device of the user during the current user interaction. Notifications to the user may be implemented according to capabilities of the IoT device and user preference data. For example, CONTP program 107 may present a generated text summary from a previous user interaction via a display of the IoT device during the current user interaction. As another example, CONTP program 107 may provide a generated text summary from a previous user interaction audibly (e.g., using text-to-speech) via a speaker of the IoT device during the current user interaction.

As an illustrative example of the contextually optimized note-taking and prompting process 200, consider a scenario in which a user, Sarah, is attending a technology conference and is equipped with a smartwatch integrated with CONTP program 107 implemented as a digital assistant. As she navigates the conference venue, CONTP program 107 detects her geolocation through GPS and contextual metadata and recognizes that she is at a tech event. CONTP program 107 automatically starts capturing audio whenever Sarah engages in conversations with other attendees using the built-in microphone of the smartwatch. During a conversation with a fellow attendee, CONTP program 107 utilizes NLP models to analyze the discussion and recognizes that they both have an interest in AI and machine learning. CONTP program 107 identifies this shared interest as an important context and begins capturing relevant information from their conversation. As Sarah and her new acquaintance delve into a discussion about the latest advancements in AI, CONTP program 107 recognizes an opportune moment when they mention an upcoming AI workshop happening later that day. Accordingly, CONTP program 107 highlights this information, considering the workshop time, location, and relevance to Sarah's interests. Later in the afternoon, CONTP program 107 notifies Sarah as the workshop's time approaches and reminds her about the workshop she discussed earlier and provides additional details of the workshop, such as the room number and the speaker's name. This timely reminder helps Sarah attend the workshop she might have otherwise missed, thanks to the opportunistic capture of the information earlier in the day. Throughout the conference, Sarah enjoys seamless interactions with CONTP program 107. It responds to her questions and comments in a natural and human-like manner, encouraging her to engage in longer conversations. This increased engagement results in more serendipitous discoveries and valuable insights. After the conference concludes, Sarah accesses her long-term memory on the smartwatch. CONTP program 107 presents a curated list of relevant notes and serendipitous moments from the event, including the workshop she attended, contact details of interesting people she met, and key insights from various discussions. Thanks to the context-awareness and contextual opportunities for notification, Sarah can easily recall valuable information and connections from the conference.

It may be appreciated that FIG. 2 provides only an illustration of some implementations and do not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, the method comprising:
transcribing audio data of a current user interaction into text data;
analyzing the text data using natural language processing to identify a context of the current user interaction;
generating, via a generative artificial intelligence (GenAI) model, one or more summaries of contextually relevant portions of the text data;
creating one or more prompts for the GenAI model based on the one or more summaries;
querying the GenAI model using the one or more prompts and using one or more existing prompts from a previous user interaction to identify a contextual opportunity for notification; and
notifying a user of the contextual opportunity for notification during the current user interaction.

2. The method of claim 1, wherein the audio data of the current user interaction is received from an Internet-of-Things (IoT) device of the user.

3. The method of claim 1, wherein the contextually relevant portions of the text data have a same context as the context of the current user interaction.

4. The method of claim 1, wherein the contextual opportunity for notification comprises a portion of transcribed text, and/or its corresponding summary, which was identified, and/or generated, during a previous user interaction, and which is contextually relevant to the context of the current user interaction.

5. The method of claim 4, wherein contextual relevance of the contextual opportunity for notification is based on a measure of contextual similarity between the contextual opportunity for user notification and the context of the current user interaction.

6. The method of claim 2, wherein the notifying comprises presenting the contextual opportunity for notification via the IoT device of the user within an optimized window of time.

7. The method of claim 1, further comprising:
storing the one or more summaries and the one or more prompts within a user repository of contextualized notes, wherein summaries and prompts stored within the user repository are indexed according to a timestamp or a timeframe of respective user interactions during which they were created.

8. A computer system, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
transcribing audio data of a current user interaction into text data;
analyzing the text data using natural language processing to identify a context of the current user interaction;
generating, via a generative artificial intelligence (GenAI) model, one or more summaries of contextually relevant portions of the text data;
creating one or more prompts for the GenAI model based on the one or more summaries;
querying the GenAI model using the one or more prompts and using one or more existing prompts from a previous user interaction to identify a contextual opportunity for notification; and
notifying a user of the contextual opportunity for notification during the current user interaction.

9. The computer system of claim 8, wherein the audio data of the current user interaction is received from an Internet-of-Things (IoT) device of the user.

10. The computer system of claim 8, wherein the contextually relevant portions of the text data have a same context as the context of the current user interaction.

11. The computer system of claim 8, wherein the contextual opportunity for notification comprises a portion of transcribed text, and/or its corresponding summary, which was identified, and/or generated, during a previous user interaction, and which is contextually relevant to the context of the current user interaction.

12. The computer system of claim 11, wherein contextual relevance of the contextual opportunity for notification is based on a measure of contextual similarity between the contextual opportunity for user notification and the context of the current user interaction.

13. The computer system of claim 9, wherein the notifying comprises presenting the contextual opportunity for notification via the IoT device of the user within an optimized window of time.

14. The computer system of claim 8, the method further comprising:
storing the one or more summaries and the one or more prompts within a user repository of contextualized notes, wherein summaries and prompts stored within the user repository are indexed according to a timestamp or a timeframe of respective user interactions during which they were created.

15. A computer program product, the computer program product comprising:
one or more computer-readable tangible storage medium and program instructions stored on at least one of the one or more tangible storage medium, the program instructions executable by a processor capable of performing a method, the method comprising:
transcribing audio data of a current user interaction into text data;
analyzing the text data using natural language processing to identify a context of the current user interaction;
generating, via a generative artificial intelligence (GenAI) model, one or more summaries of contextually relevant portions of the text data;
creating one or more prompts for the GenAI model based on the one or more summaries;
querying the GenAI model using the one or more prompts and using one or more existing prompts from a previous user interaction to identify a contextual opportunity for notification; and
notifying a user of the contextual opportunity for notification during the current user interaction.

16. The computer program product of claim 15, wherein the audio data of the current user interaction is received from an Internet-of-Things (IoT) device of the user.

17. The computer program product of claim 15, wherein the contextually relevant portions of the text data have a same context as the context of the current user interaction.

18. The computer program product of claim 15, wherein the contextual opportunity for notification comprises a portion of transcribed text, and/or its corresponding summary, which was identified, and/or generated, during a previous user interaction, and which is contextually relevant to the context of the current user interaction.

19. The computer program product of claim 18, wherein contextual relevance of the contextual opportunity for notification is based on a measure of contextual similarity between the contextual opportunity for user notification and the context of the current user interaction.

20. The computer program product of claim 16, wherein the notifying comprises presenting the contextual opportunity for notification via the IoT device of the user within an optimized window of time.
